(19) United States
(12) Patent Application Publication
(10) Pub. No.: US 2026/0246530 A1
(43) Pub. Date: Aug. 20, 2026

(54) SPECTRUM SHARING IN NTN-TN COORDINATION

(71) Applicant: MediaTek Singapore Pte. Ltd., Singapore (SG)

(72) Inventors: Abdelkader MEDLES, Cambridge (GB); Gilles CHARBIT, Cambridge (GB); Mehmet KUNT, Cambridge (GB); Pradeep JOSE, Cambridge (GB); I-Kang FU, Hsinchu City (TW); Abhishek ROY, San Jose, CA (US)

(21) Appl. No.: 19/642,866

(22) Filed: Apr. 9, 2026

Related U.S. Application Data
(63) Continuation of application No. 18/254,395, filed on Nov. 23, 2021, now abandoned.
(60) Provisional application No. 63/118,669, filed on Nov. 26, 2020.

(51) Int. Cl. H04B 7/185; H04W 24/08

(52) U.S. Cl. CPC H04B 7/18519; H04W 24/08

(57) ABSTRACT

Solutions pertaining to spectrum sharing in coordination between a non-terrestrial network (NTN) and a terrestrial network (TN) are described. An apparatus implemented in a UE includes a transceiver configured to communicate wirelessly and a processor coupled to the transceiver and configured to perform operations. The processor measures a signal strength of each of one or more terrestrial network (TN) cells and one or more non-terrestrial network (NTN) cells, reports, via the transceiver, a result of the measuring to a network, and receives, via the transceiver, an indication from the network configuring and activating a bandwidth part (BWP) that separates transmission by a base station of the TN from NTN downlink (DL) transmissions.

### CROSS REFERENCE TO RELATED PATENT APPLICATION

The present disclosure is a continuation of pending U.S. Utility Patent Application No. 18/254,395, filed on May 25, 2023, which is a 371 National Phase Patent Application of PCT Patent Application No. PCT/CN2021/132252, filed on November 23, 2021, which is part of a non-provisional application claiming the priority benefit of U.S. Provisional Patent Application No. 63/118,669, filed on 26 November 2020, the content of which being incorporated by reference in its entirety.

### TECHNICAL FIELD

The present disclosure is generally related to mobile communications and, more particularly, to spectrum sharing in coordination between a non-terrestrial network (NTN) and a terrestrial network (TN).

### BACKGROUND

Unless otherwise indicated herein, approaches described in this section are not prior art to the claims listed below and are not admitted as prior art by inclusion in this section.

In wireless communications such as mobile communications according to the 3rd Generation Partnership Project (3GPP) specifications, spectrum sharing refers to two systems sharing the same carriers. For instance, in the context of TN-NTN spectrum sharing, the TN can reuse the same spectrum used by the NTN. This can free up a lot of spectrum for TN reuse. One challenge, however, is TN-to-NTN interference. Additionally, it is noteworthy that NTN satellite power on the ground tends to be relatively small. That is, NTN (e.g., satellite) power reaching a TN user equipment (UE) is typically significantly low (e.g., close to thermal noise floor) for most UEs that are within TN coverage. NTN UEs are expected to be outside of TN coverage, and thus the level of interference on TN network from NTN UEs tends to be low. On the other hand, one main challenge is TN interference on uplink (UL) transmissions from a NTN UE to a satellite. As a satellite beam can cover large areas, aggregate TN interference on NTN UL transmissions can be very high. Moreover, due to geographical separation, TN interference on downlink (DL) transmissions to NTN UEs tends to be less problematic.

For standard pairing, the NTN and TN systems would share the same resources for DL transmissions and the same resources for UL transmissions. On the DL, if the TN and NTN share the same bandwidth, the mobility management could handle the interference. Signal quality of the TN (e.g., reference signal received power (RSRP), reference signal received quality (RSRQ), signal-to-noise ratio (SNR) and the like) should be much better than signal quality of the NTN in most of the cases when the coverage of the TN and the coverage of the NTN overlap. The UE should stay on the TN in most of the cases even if the NTN is causing interference on the TN. Therefore, there is a need for a solution for spectrum sharing in NTN-TN coordination to address aforementioned issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure pertain to spectrum sharing in NTN-TN coordination.

In one aspect, a method may involve a UE measuring a signal strength of each of one or more TN cells and one or more NTN cells. The method may also involve the UE reporting a result of the measuring to a TN.

In one aspect, a method may involve a UE receiving an indication from the TN configuring and activating a bandwidth part (BWP) that separates transmission by a base station of the TN from NTN DL transmissions.

In yet another aspect, an apparatus may include a transceiver and a processor coupled to the transceiver. The transceiver may be configured to communicate wirelessly. The processor may measure, via the transceiver, a signal strength of each of one or more TN cells and one or more NTN cells. The processor may also report, via the transceiver, a result of the measuring to a TN.

In still another aspect, an apparatus may include a transceiver and a processor coupled to the transceiver. The transceiver may be configured to communicate wirelessly. The processor may receive, via the transceiver, an indication from the TN configuring and activating a BWP that separates transmission by a base station of the TN from NTN DL transmissions.

It is noteworthy that, although description provided herein may be in the context of certain radio access technologies, networks and network topologies such as TN and NTN, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario under a proposed scheme in accordance with the present disclosure.

FIG. 2 is a diagram of an example scenario under a proposed scheme in accordance with the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### OVERVIEW

Implementations in accordance with the present disclosure relate to various techniques, methods, schemes and/or solutions pertaining to spectrum sharing in NTN-TN coordination. According to the present disclosure, a number of possible solutions may be implemented separately or jointly. That is, although these possible solutions may be described below separately, two or more of these possible solutions may be implemented in one combination or another.

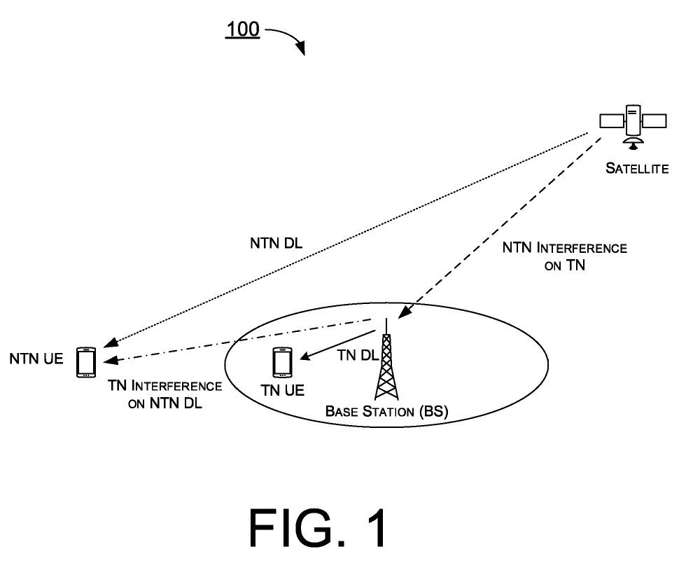

FIG. 1 illustrates an example scenario 100 under a proposed scheme with respect to TN-NTN mobility management in accordance with the present disclosure. It is noteworthy that there may be cases in which the signal quality experienced by a UE in a TN is not good, or otherwise less than desirable, and the UE should switch to the NTN. For instance, one possible case is at the very edge of an area under TN coverage. Accordingly, a criterion related to signal quality (e.g., RSRP, RSRQ, SNR and/or channel fading) may be used to determine mobility switching from the TN to an NTN, although it may still be preferable for the UE to stay on the TN as much as possible.

Under the proposed scheme, TN versus NTN-based mobility criterion may be implemented to avoid unnecessary switch from the TN to the NTN due to satellite mobility. Specifically, the UE may implement a mobility criterion related to signal quality (e.g., based on RSRP, RSRQ, SNR, UE location and the like) in choosing between TN and NTN cells. Moreover, different thresholds may be applied to TN and NTN cells to ensure that TN cells are prioritized over NTN cells. This may be achieved by introducing offsets to boost the rank of one or more TN cells, or to reduce the rank of one or more NTN cells, or to ensure that measurement events are only triggered in case a signal strength of NTN cell(s) is significantly above the TN cell(s). For instance, this technique may be implemented through measurement events specific for NTN/TN.

Accordingly, the UE may need to know certain information about the NTN cells (e.g., via new signaling from the TN and/or NTN). The new signaling may be included in the broadcast information of NTN cells being measured (e.g., master information block (MIB)), which may take the form of NTN or TN characteristic in the system information block (SIB). Alternatively, the new signaling may be in the form of specific information about the NTN cells to be measured. For instance, the measurement object may include information indicating that the cells in the measurement object are NTN cells. Moreover, NTN long-term ephemeris (e.g., cell layout, coverage time, and the like) may be used by the UE in addition to a TN neighbor list.

Under the proposed scheme, when reporting one or more measured NTN cells to a TN serving cell, the UE may indicate that the cell(s) measured is/are NTN cell(s). Similarly, when reporting one or more measured TN cells to an NTN serving cell, the UE may indicate that the cell(s) measured is/are TN cell(s). New signaling may be included as part of the measurement report being sent by the UE to the serving cell, whether a TN serving cell or an NTN serving cell.

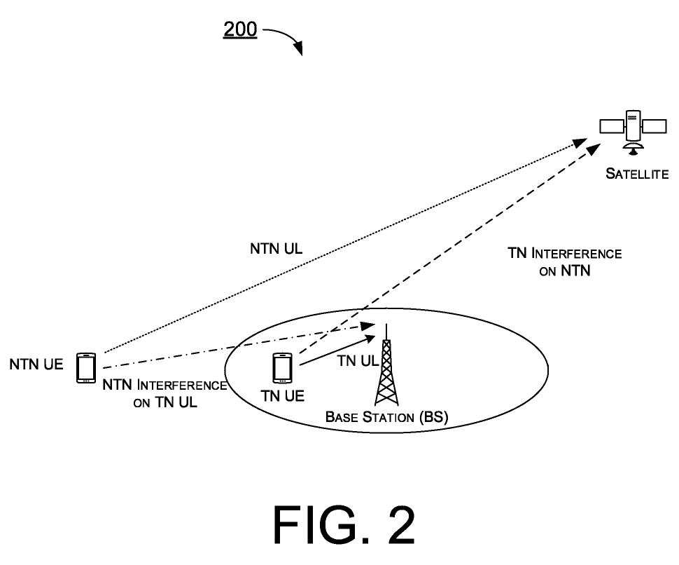

FIG. 2 illustrates an example scenario 200 under a proposed scheme with respect to BWP switching in accordance with the present disclosure. It is noteworthy that, on the UL, all TN UEs in a TN cell may cause interference on an NTN, especially when there are a very large number of UEs (e.g., potentially thousands or more) at a given time. On the other hand, interference caused by NTN UEs on TN UEs tends to be much less of a problem, especially since the number of NTN UEs tends to be limited and generally not in cell coverage. That is, the level of signal from an NTN UE reaching a base station (BS) of a TN tends to be very low. Under the proposed scheme, several approaches may be undertaken to reduce the TN-to-NTN interference. For instance, a very strict frequency domain separation for a Low-Earth-orbit (LEO) satellite. Additionally, a BWP mechanism may be re-used. Moreover, certain information may be included in broadcast or group common BWP switching, which may be radio resource control (RRC) or downlink control information (DCI) based, timer based, and/or location based.

Under the proposed scheme, group common BWP switching may be implemented using a group common DCI. This group common DCI may be monitored in a common search space. Alternatively, or additionally, group common BWP switching may be implemented using RRC reconfiguration to lower overhead. Alternatively, a dedicated SIB information broadcast may be utilized. Alternatively, or additionally, a time reference may be specified to trigger a timer-based BWP switching. For instance, the timer-based BWP switching may be linked to satellite ephemeris or other satellite availability information. Alternatively, or additionally, a location-based BWP switching may involve a UE-initiated BWP switching based on a location of the UE, similar to consistent listen-before-talk (LBT) failure detection in New Radio unlicensed spectrum (NR-U).

For TN DL transmissions interfering with NTN DL transmissions on a forward link, there may be TN and NTN measurements and reports by an NTN UE to a TN network, and then BWP configuration and activation may be utilized to separate transmissions of a TN base station (e.g., gNB) from NTN DL transmissions in the NTN UE. Under the proposed scheme, broadcast on a SIB of TN or NTN types may be utilized to identify measurement events for TN or NTN. Additionally, timer-based mechanisms and UE group conditional handover (CHO) for beam switching of TN UEs on DL may be done with long-term knowledge of satellite ephemeris. In such cases, the UE may trigger measurements and reports, and the UE may autonomously activate a configured BWP. The TN network may indicate a UE group CHO command in DCI. The long-term ephemeris may include information on the number of beams per NTN cell and mapping to synchronization signal blocks (SSBs) as well as a configuration of an initial BWP#0. Under the proposed scheme, SSB measurements in the initial BWP#0 of TN or NTN cell by the UE may be sufficient. It does not need to be very accurate and this may limit the amount of signaling as there is no need, and this may indicate other BWP#X configurations including channel state information (CSI) reference signal (RS) for NTN cell(s). Moreover, the UE may report its location and the network may determine to indicate to the UE to switch BWPs or refrain from scheduling to the UE until the satellite flies by. The network may have access to the long-term satellite ephemeris.

For TN UL transmissions interfering with NTN devices on a return link, geographical separate between TN and NTN cells may not be possible. The network with knowledge of the long-term satellite ephemeris may configure BWPs to preserve a guard band for mitigation of out-of-band (OOB) emissions. The granularity of the specified BWP configurations for TN may be sufficient to allow the gNB to activate or deactivate configured BWPs based on the given beams in an NTN cell regarding which the satellite is flying by. Additionally, timer-based activation and deactivation and UE group CHO for beam switching of TN UEs on UL transmissions may be mechanisms used by the network. Under the proposed scheme, the DL and UL beam switching of TN UEs may be paired (e.g., done at the same time to reduce signaling overhead). Moreover, TN UEs close to the gNB of the TN with UL transmission power control by UL Power Control (UPC) (and hence relatively smaller) may be configured a BWP with a smaller guard band. These UEs close to the gNB may increase their power via Transmit Power Control (TPC) on DCI in case that NTN UL transmissions cause significant interference. Furthermore, it may be possible to have no guard band at all and even share the same band between TN and NTN for these UEs.

Under a proposed scheme in accordance with the present disclosure with respect to OOB emission reduction capability, a TN cell may adapt a BWP based on the satellite in view. Advantageously, the channel bandwidth (BW) and/or OOB emission may be already configured per BWP. However, spectrum emission mask may need to be improved (e.g., -10dBm to -13dBm per 1MHz only). In case that 10,000 TN UEs are interfering NTN with -10dBm, the total interference power may be approximately 30dBm. For an NTN UE at 23dBm, the signal-to-interference ratio (SIR) may be -7dB. Thus, under the proposed scheme, each UE may be configured with a UE capability to support TN-NTN spectrum sharing with tighter OOB emissions (e.g., with an OOB emission mask no greater than a predefined threshold such as an OOB emission mask with no TN-NTN spectrum sharing).

### Illustrative Implementations

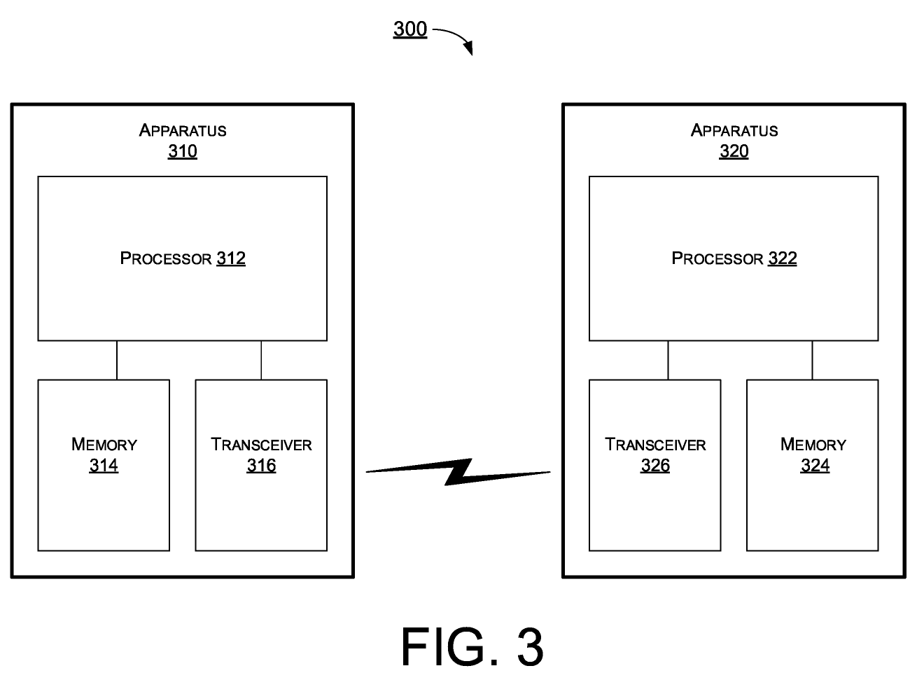

FIG. 3 illustrates an example communication system 300 having an example apparatus 310 and an example apparatus 320 in accordance with an implementation of the present disclosure. Each of apparatus 310 and apparatus 320 may perform various functions to implement schemes, techniques, processes and methods described herein pertaining to spectrum sharing in NTN-TN coordination, including scenarios/schemes described above as well as process(es) described below.

Apparatus 310 may be a part of an electronic apparatus, which may be a UE such as a portable or mobile apparatus, a wearable apparatus, a wireless communication apparatus or a computing apparatus. For instance, apparatus 310 may be implemented in a smartphone, a smartwatch, a personal digital assistant, a digital camera, or a computing equipment such as a tablet computer, a laptop computer or a notebook computer. Apparatus 310 may also be a part of a machine type apparatus, which may be an IoT, NB-IoT, IIoT or NTN apparatus such as an immobile or a stationary apparatus, a home apparatus, a wire communication apparatus or a computing apparatus. For instance, apparatus 310 may be implemented in a smart thermostat, a smart fridge, a smart door lock, a wireless speaker or a home control center. Alternatively, apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 310 may include at least some of those components shown in FIG. 3 such as a processor 312, for example. Apparatus 310 may further include one or more other components not pertinent to the proposed scheme of the present disclosure (e.g., internal power supply, display device and/or user interface device), and, thus, such component(s) of apparatus 310 are neither shown in FIG. 3 nor described below in the interest of simplicity and brevity.

Apparatus 320 may be a part of an electronic apparatus/station, which may be a network node such as a base station, a small cell, a router, a gateway or a satellite. For instance, apparatus 320 may be implemented in an eNodeB in an LTE, in a gNB in a 5G, NR, IoT, NB-IoT, IIoT, or in a satellite in an NTN network. Alternatively, apparatus 320 may be implemented in the form of one or more IC chips such as, for example and without limitation, one or more single-core processors, one or more multi-core processors, or one or more RISC or CISC processors. Apparatus 320 may include at least some of those components shown in FIG. 3 such as a processor 322, for example. Apparatus 320 may further include one or more other components not pertinent to the proposed scheme of the present disclosure (e.g., internal power supply, display device and/or user interface device), and, thus, such component(s) of apparatus 320 are neither shown in FIG. 3 nor described below in the interest of simplicity and brevity.

In one aspect, each of processor 312 and processor 322 may be implemented in the form of one or more single-core processors, one or more multi-core processors, one or more RISC processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including spectrum sharing in NTN-TN coordination in accordance with various implementations of the present disclosure.

In some implementations, apparatus 310 may also include a transceiver 316 coupled to processor 312 and capable of wirelessly transmitting and receiving data. In some implementations, apparatus 310 may further include a memory 314 coupled to processor 312 and capable of being accessed by processor 312 and storing data therein. In some implementations, apparatus 320 may also include a transceiver 326 coupled to processor 322 and capable of wirelessly transmitting and receiving data. In some implementations, apparatus 320 may further include a memory 324 coupled to processor 322 and capable of being accessed by processor 322 and storing data therein. Accordingly, apparatus 310 and apparatus 320 may wirelessly communicate with each other via transceiver 316 and transceiver 326, respectively.

Each of apparatus 310 and apparatus 320 may be a communication entity capable of communicating with each other using various proposed schemes in accordance with the present disclosure. To aid better understanding, the following description of the operations, functionalities and capabilities of each of apparatus 310 and apparatus 320 is provided in the context of a mobile communication environment in which apparatus 310 is implemented in or as a communication apparatus or a UE (e.g., NTN UE) and apparatus 320 is implemented in or as a network node or base station (e.g., NT network node such as a satellite) of a communication network (e.g., NTN). It is also noteworthy that, although the example implementations described below are provided in the context of mobile communications, the same may be implemented in other types of networks.

Under some proposed schemes pertaining to spectrum sharing in NTN-TN coordination in accordance with the present disclosure, with apparatus 310 implemented in or as an NTN UE and apparatus 320 implemented in or as a base station (e.g., gNB) of a TN or a satellite of an NTN, processor 312 may measure, via transceiver 316, a signal strength of each of one or more TN cells and one or more NTN cells. Additionally, processor 312 may report, via transceiver 316, a result of the measuring to a TN (e.g., via apparatus 320 as a base station, such as a gNB, of the TN).

In some implementations, in measuring, processor 312 may perform an SSB measurement in an initial BWP of a cell among the one or more TN cells and the one or more NTN cells. In some implementations, the SSB measurement may include an SSB measurement on the one or more NTN cells based on a long-term ephemeris. In some implementations, the long-term ephemeris may include a number of beams per NTN cell, mapping to SSBs, and a configuration of the initial BWP.

In some implementations, processor 312 may perform one or more additional operations. For instance, processor 312 may receive, via transceiver 316, an SIB from apparatus 320 indicating whether a cell measured by the UE is of the TN or the NTN to identify measurement events for the TN or the NTN. Additionally, processor 312 may receive, via transceiver 316, a higher-layer signaling (e.g., RRC signaling) that configures a measurement object with respect to the one or more TN cells and the one or more NTN cells.

Under some proposed schemes pertaining to spectrum sharing in NTN-TN coordination in accordance with the present disclosure, with apparatus 310 implemented in or as an NTN UE and apparatus 320 implemented in or as a base station (e.g., gNB) of a TN or a satellite of an NTN, processor 312 may receive, via transceiver 316, an indication from the TN configuring and activating a BWP that separates transmission by apparatus 320 of the TN from NTN DL transmissions.

In some implementations, the indication may include a DCI indication.

In some implementations, the UE may be configured with a capability of supporting TN-NTN spectrum sharing with an OOB emission mask no greater than a threshold.

In some implementations, processor 312 may perform one or more additional operations. For instance, processor 312 may receive, via transceiver 316, a DCI signaling that indicates UE group common BWP switching. Additionally, processor 312 may receive, via transceiver 316, a higher-layer signaling (e.g., RRC signaling) that configures UE group common BWP switching. Additionally, processor 312 may receive, via transceiver 316, a configuration (e.g., from apparatus 320) that configures a timer used in BWP switching. Additionally, processor 312 may receive, via transceiver 316, a configuration (e.g., from apparatus 320) that configures location-based BWP switching.

### Illustrative Processes

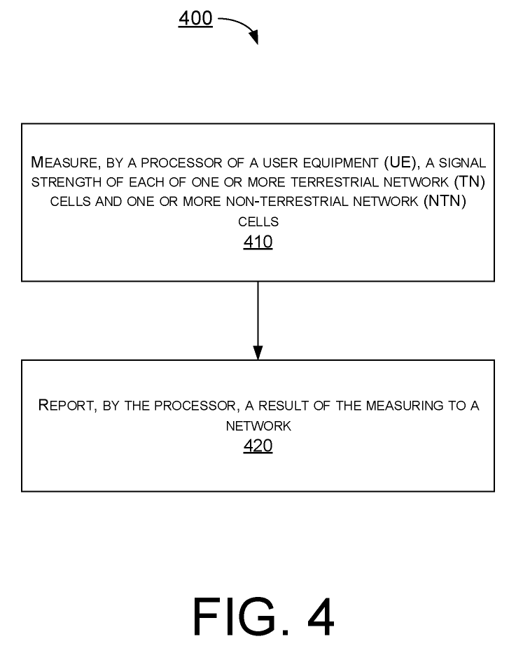

FIG. 4 illustrates an example process 400 in accordance with an implementation of the present disclosure. Process 400 may be an example implementation of schemes described above whether partially or completely, with respect to spectrum sharing in NTN-TN coordination in accordance with the present disclosure. Process 400 may represent an aspect of implementation of features of apparatus 310 and/or apparatus 320. Process 400 may include one or more operations, actions, or functions as illustrated by blocks 410 and 420. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by apparatus 310 or any suitable UE or machine type devices. Solely for illustrative purposes and without limitation, process 400 is described below in the context of apparatus 310 implemented in or as an NTN UE and apparatus 320 implemented in or as a base station (e.g., gNB) of a TN or a satellite of an NTN. Process 400 may begin at block 410.

At 410, process 400 may involve processor 312 of apparatus 310 as a UE measuring, via transceiver 316, a signal strength of each of one or more TN cells and one or more NTN cells. Process 400 may proceed from 410 to 420.

At 420, process 400 may involve processor 312 reporting, via transceiver 316, a result of the measuring to a TN (e.g., via apparatus 320 as a base station, such as a gNB, of the TN).

In some implementations, in measuring, process 400 may involve processor 312 performing an SSB measurement in an initial BWP of a cell among the one or more TN cells and the one or more NTN cells. In some implementations, the SSB measurement may include an SSB measurement on the one or more NTN cells based on a long-term ephemeris. In some implementations, the long-term ephemeris may include a number of beams per NTN cell, mapping to SSBs, and a configuration of the initial BWP.

In some implementations, process 400 may involve processor 312 performing one or more additional operations. For instance, process 400 may involve processor 312 receiving, via transceiver 316, an SIB from apparatus 320 indicating whether a cell measured by the UE is of the TN or the NTN to identify measurement events for the TN or the NTN. Additionally, process 400 may involve processor 312 receiving, via transceiver 316, a higher-layer signaling (e.g., RRC signaling from apparatus 320) that configures a measurement object with respect to the one or more TN cells and the one or more NTN cells.

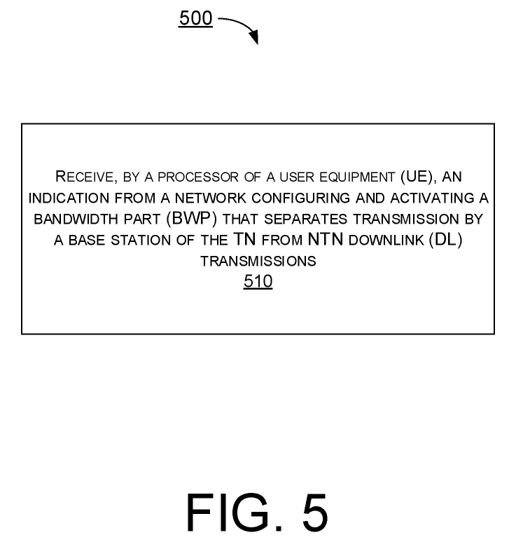

FIG. 5 illustrates an example process 500 in accordance with an implementation of the present disclosure. Process 500 may be an example implementation of schemes described above whether partially or completely, with respect to spectrum sharing in NTN-TN coordination in accordance with the present disclosure. For instance, process 500 may be a continuation of process 400 in that process 500 may be performed in conjunction with and/or subsequent to process 400. Process 500 may represent an aspect of implementation of features of apparatus 310 and/or apparatus 320. Process 500 may include one or more operations, actions, or functions as illustrated by block 510. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by apparatus 310 or any suitable UE or machine type devices. Solely for illustrative purposes and without limitation, process 500 is described below in the context of apparatus 310 implemented in or as an NTN UE and apparatus 320 implemented in or as a base station (e.g., gNB) of a TN or a satellite of an NTN. Process 500 may begin at block 510.

At 510, process 500 may involve processor 312 of apparatus 310 as a UE receiving, via transceiver 316, an indication from a network (e.g., via apparatus 320 as a base station, such as a gNB, of the TN) configuring and activating a BWP that separates transmission by apparatus 320 of the TN from NTN DL transmissions.

In some implementations, the indication may include a DCI indication.

In some implementations, the UE may be configured with a capability of supporting TN-NTN spectrum sharing with an OOB emission mask no greater than a threshold.

In some implementations, process 400 may involve processor 312 performing one or more additional operations. For instance, process 400 may involve processor 312 receiving, via transceiver 316, a DCI signaling (e.g., from apparatus 320) that indicates UE group common BWP switching. Additionally, process 400 may involve processor 312 receiving, via transceiver 316, a higher-layer signaling (e.g., RRC signaling from apparatus 320) that configures UE group common BWP switching. Additionally, process 400 may involve processor 312 receiving, via transceiver 316, a configuration (e.g., from apparatus 320) that configures a timer used in BWP switching. Additionally, process 400 may involve processor 312 receiving, via transceiver 316, a configuration (e.g., from apparatus 320) that configures location-based BWP switching.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a processor of a user equipment (UE), a signal strength of each of one or more terrestrial network (TN) cells and one or more non-terrestrial network (NTN) cells; and
reporting, by the processor, a result of the measuring to a network; and
receiving, by the processor, an indication from the network configuring and activating a bandwidth part (BWP) that separates transmission by a base station of the TN from NTN downlink (DL) transmissions.

2. The method of claim 1, wherein the indication comprises a downlink control information (DCI) indication.

3. The method of claim 1, wherein the UE is configured with a capability of supporting TN-NTN spectrum sharing with an out-of-band (OOB) emission mask no greater than a threshold.

4. The method of claim 1, further comprising:
receiving, by the processor, a downlink control information (DCI) signaling from the network indicating UE group common BWP switching.

5. The method of claim 1, further comprising:
receiving, by the processor, a higher-layer signaling from the network configuring at least one of a UE group common BWP switching and a measurement object with respect to the one or more TN cells and the one or more NTN cells.

6. The method of claim 1, further comprising:
receiving, by the processor, a configuration from the network configuring a timer used in BWP switching.

7. The method of claim 1, further comprising:
receiving, by the processor, a configuration from the network configuring location-based BWP switching.

8. The method of claim 1, wherein the measuring comprises performing a synchronization signal block (SSB) measurement in an initial BWP of a cell among the one or more TN cells and the one or more NTN cells.

9. The method of claim 1, further comprising:
receiving, by the processor, a system information block (SIB) from the network indicating whether a cell measured by the UE is of the TN or the NTN to identify measurement events for the TN or the NTN.

10. The method of claim 9, wherein the measurement events are specific for NTN cells and TN cells.

11. The method of claim 9, wherein a threshold used in the measurement events is specific for NTN cells and TN cells for the same measurement event.

12. An apparatus implementable in a user equipment (UE), comprising:
a transceiver configured to communicate wirelessly; and
a processor coupled to the transceiver and configured to perform operations comprising:
measuring a signal strength of each of one or more terrestrial network (TN) cells and one or more non-terrestrial network (NTN) cells; and
reporting, via the transceiver, a result of the measuring to a network; and
receiving, via the transceiver, an indication from the network configuring and activating a bandwidth part (BWP) that separates transmission by a base station of the TN from NTN downlink (DL) transmissions.

13. The method of claim 12, wherein the indication comprises a downlink control information (DCI) indication.

14. The apparatus of claim 12, wherein the indication comprises a downlink control information (DCI) indication, and wherein the UE is configured with a capability of supporting TN-NTN spectrum sharing with an out-of-band (OOB) emission mask no greater than a threshold.

15. The apparatus of claim 12, wherein the processor is further configured to perform operations comprising:
receiving, via the transceiver, a downlink control information (DCI) signaling from the network indicating UE group common BWP switching.

16. The apparatus of claim 12, wherein the processor is further configured to perform operations comprising:
receiving, via the transceiver, a higher-layer signaling from the network configuring at least one of a UE group common BWP switching and a measurement object with respect to the one or more TN cells and the one or more NTN cells.

17. The apparatus of claim 12, wherein the processor is further configured to perform operations comprising:
receiving, via the transceiver, a configuration from the network configuring a timer used in BWP switching.

18. The apparatus of claim 12, wherein the processor is further configured to perform operations comprising:
receiving, via the transceiver, a configuration from the network configuring location-based BWP switching.

19. The apparatus of claim 12, wherein the measuring comprises performing a synchronization signal block (SSB) measurement in an initial BWP of a cell among the one or more TN cells and the one or more NTN cells.

20. The apparatus of claim 12, wherein the processor is further configured to perform operations comprising:
receiving, via the transceiver, a system information block (SIB) from the network indicating whether a cell measured by the UE is of the TN or the NTN to identify measurement events for the TN or the NTN.
